(19) United States
(12) Patent Application Publication
(10) Pub. No.: US 2023/0245426 A1
(43) Pub. Date: Aug. 3, 2023

(54) IMAGE PROCESSING METHOD AND APPARATUS FOR MEDICAL IMAGE, DEVICE AND STORAGE MEDIUM

(71) Applicant: Tencent Technology (Shenzhen) Company Limited, Shenzhen (CN)

(72) Inventor: Yi LIN, Shenzhen (CN)

(21) Appl. No.: 18/132,824

(22) Filed: Apr. 10, 2023

Related U.S. Application Data
(63) Continuation of application No. PCT/CN2022/107341, filed on Jul. 22, 2022.

(30) Foreign Application Priority Data
Aug. 16, 2021 (CN) 202110938701.X

(51) Int. Cl. G06V 10/77; G06V 10/82; G06V 10/26; G06V 10/774; G06V 10/776; G06V 10/80

(52) U.S. Cl. CPC G06V 10/7715; G06V 10/82; G06V 10/26; G06V 10/774; G06V 10/776; G06V 10/806; G06V 2201/03

(57) ABSTRACT

A method for processing a medical image performed by a computer device. The method includes: calling a first coding network in an image processing model to code a first sample image of a first mode of a target medical object, to obtain a first feature map of the first sample image; calling a decoding network to obtain, based on the first feature map, a predictive segmentation image used for indicating at least one predicted specified type region within the first sample image; calling a generative network to generate a predictive generation image of a second mode based on the first feature map; and training the image processing model based on a difference between the predictive segmentation image and a tag image of the target medical object and a difference between the predictive generation image and a second sample image of a second mode of the target medical object.

### CROSS-REFERENCE TO RELATED APPLICATIONS

This application is a continuation application of PCT Patent Application No. PCT/CN2022/107341, entitled “IMAGE PROCESSING METHOD AND APPARATUS FOR MEDICAL IMAGE, DEVICE AND STORAGE MEDIUM” filed on Jul. 22, 2022, which claims priority to Chinese Patent Application No. 202110938701.X filed on Aug. 16, 2021 and entitled “IMAGE PROCESSING METHOD AND APPARATUS FOR MEDICAL IMAGE, DEVICE AND STORAGE MEDIUM”, all of which is incorporated herein by reference in its entirety.

### FIELD OF THE TECHNOLOGY

This application relates to the field of medical technologies, and in particular, to an image processing method and apparatus for a medical image, a device, and a storage medium.

### BACKGROUND OF THE DISCLOSURE

In the medical field, medical image segmentation through medical imaging technology has become a common technique to assist doctors in case judgment.

In related technologies, medical images are usually inputted into a neural network model, and medical image segmentation is performed based on medical image features extracted by a neural network, to obtain a medical image segmentation result.

However, the neural network model in the technologies often focuses on the medical image features and the strong expressive features of the inputted medical images, and pays less attention to the weak expressive features in the medical images, so that information contained in the obtained medical image segmentation results is not comprehensive, making the medical image segmentation effect poor.

### SUMMARY

Embodiments of this application provide an image processing method and apparatus for a medical image, a device, and a storage medium. The technical solutions are as follows:

On the one hand, provided is a method for processing a medical image, executed by a computer device, the method including:

calling a first coding network in an image processing model to code a first sample image of a first mode of a target medical object, to obtain a first feature map of the first sample image;

calling a decoding network in the image processing model to perform decoding based on the first feature map, to obtain a predictive segmentation image of the first sample image, the predictive segmentation image being used for indicating at least one predicted specified type region within the first sample image;

calling a generative network in the image processing model to generate a predictive generation image based on the first feature map, the predictive generation image being a prediction image of a second mode of the first sample image; and

training the image processing model based on a difference between the predictive segmentation image and a tag image of the target medical object and a difference between the predictive generation image and a second sample image of a second mode of the target medical object, and the tag image indicating the at least one specified type region of the target medical object.

On the other hand, provided is a computer device, including a processor and a memory, where the memory stores at least one instruction, and the at least one instruction is loaded and executed by the processor and cause the computer device to implement the method for processing a medical image.

On the other hand, provided is a non-transitory computer-readable storage medium having at least one computer program stored thereon, the computer program being loaded and executed by a processor of a computer device and causing the computer device to implement the image processing method for a medical image.

On the other hand, provided is a computer program product or a computer program, including computer instructions stored in a non-transitory computer-readable storage medium. The processor of the computer device reads the computer instructions from the computer-readable storage medium. The processor executes the computer instructions so that the computer device executes the image processing method for a medical image provided in each optional implementation.

According to the image processing method for a medical image provided by the embodiments of this application, by obtaining a sample medical image of a multi-mode of a target medical object and a tag image of the target medical image including a specified type region tag, generating a predictive segmentation image and a predictive generation image based on a first sample image in the sample medical image of the multi-mode, and training an image processing module including a first coding network, a decoding network and a generative network based on a difference between the predictive segmentation image and the tag image and a difference between the predictive generation image and a second sample image of the target medical object, the trained image processing model may obtain features of a medical image of a multi-mode based on a medical image of a single mode, so that information included in the obtained medical image segmentation result is relatively comprehensive, improving the segmentation result of the medical image.

Furthermore, medical images of other modes can be generated by the trained image processing model based on the medical image of the single mode, so that the image missing problem in the medical image analysis process is solved.

### BRIEF DESCRIPTION OF THE DRAWINGS

FIG. 1 is a schematic diagram of a system architecture of an image processing method for a medical image according to an exemplary embodiment of this application.

FIG. 2 is a flowchart of an image processing method for a medical image according to an exemplary embodiment of this application.

FIG. 3 is a frame diagram of image processing model generation and image processing according to an exemplary embodiment.

FIG. 4 is a flowchart of an image processing method for a medical image according to an exemplary embodiment of this application.

FIG. 5 is a flowchart of an image processing method for a medical image according to an exemplary embodiment of this application.

FIG. 6 is a schematic composite diagram of an approximate mark according to an exemplary embodiment of this application.

FIG. 7 is a schematic structural diagram of an image processing model according to an exemplary embodiment of this application.

FIG. 8 is a schematic structural diagram of a coding layer according to an exemplary embodiment of this application.

FIG. 9 is a schematic structural diagram of a decoding layer according to an exemplary embodiment of this application.

FIG. 10 is a schematic diagram of an application process of an image processing model according to an exemplary embodiment of this application.

FIG. 11 is a block diagram of an image processing apparatus for a medical image according to an exemplary embodiment of this application.

FIG. 12 is a schematic block diagram of a computer device according to an exemplary embodiment of this application.

FIG. 13 is a schematic block diagram of a computer device according to an exemplary embodiment of this application.

### DESCRIPTION OF EMBODIMENTS

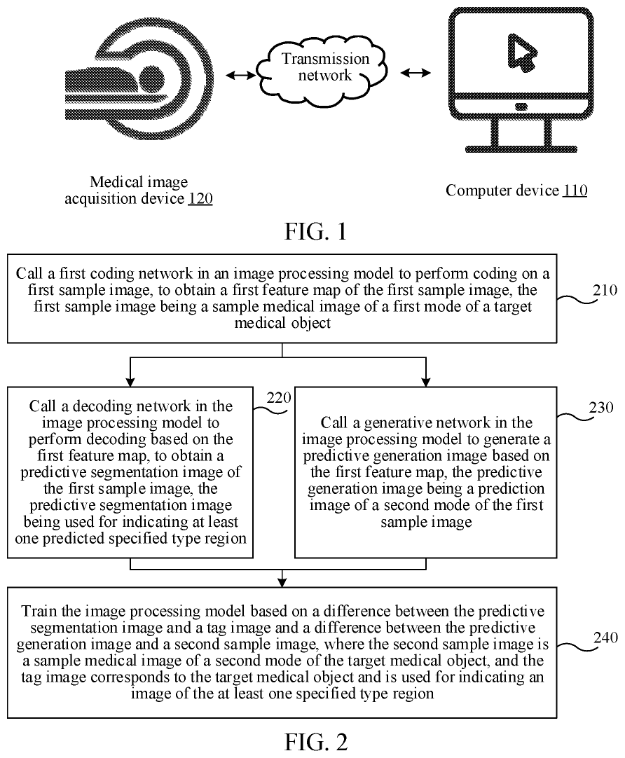

FIG. 1 is a schematic diagram of a system architecture of an image processing method for a medical image according to an exemplary embodiment of this application. As shown in FIG. 1, the system includes: a computer device 110 and a medical image acquisition device 120.

The computer device 110 may be implemented as a terminal or a server. When the computer device 110 is implemented as the server, the computer device 110 may be an independent physical server, a server cluster or distributed system composed of multiple physical servers, and a cloud server providing basic cloud computing services, such as cloud services, cloud databases, cloud computing, cloud functions, cloud storage, network services, cloud communications, middleware services, domain name services, security services, Content Delivery Networks (CDN), big data and artificial intelligence platforms. When the computer device 110 is implemented as the terminal, the computer device 110 may be a smart phone, a tablet computer, a laptop portable computer, and a desktop computer, etc.

The medical image acquisition device 120 is a device having a medical image acquisition function. For example, the medical image acquisition device may be a Computed Tomography (CT) detector for medical testing, a nuclear magnetic resonance spectrometer, a positron emission CT scanner, a cardiac magnetic resonance spectrometer and other devices with an image acquisition apparatus. Schematically, taking the cardiac magnetic resonance spectrometer as an example, Cardiac Magnetic Resonance (CMR) refers to the method of using a magnetic resonance imaging technique to diagnose cardiac and macrovascular diseases. Magnetic resonance is a non-invasive imaging technique. CMR images obtained based on cardiac magnetic resonance imaging may provide anatomical and functional information of the heart to assist in clinical diagnosis and treatment of cardiac diseases, for example, the CMR images may assist in clinical diagnosis and treatment of myocardial infarction.

The CMR is a multi-mode imaging method. Different CMR imaging sequences correspond to different imaging focuses to provide different cardiac feature information. Schematically, the CMR imaging sequences may include: balanced-Steady State Free Precession (bSSFP), which may capture cardiac movement so that a corresponding bSSFP image may show a complete and clear myocardial boundary; T2-weighted imaging, a corresponding T2-weighted image of which may clearly show myocardial edema or myocardial ischemic injury, for example, the T2-weighted image shows the site of myocardial edema or myocardial ischemic injury in a highlighted form; and Late Gadolinium Enhancement (LGE) technology, a corresponding LGE image of which may highlight the region of myocardial scarring or myocardial infarction. By combining multiple image sequences, rich and reliable information about myocardial pathology and morphology may be obtained, to assist in setting a clinical diagnosis and treatment plan. The above description of the imaging sequence of CMR is only illustrative, and the relevant personnel may set different imaging sequences according to actual needs to obtain different CMR images, which is not limited in this application. Furthermore, the multi-mode medical images as shown in this application may be medical images corresponding to a same medical object obtained based on different medical image acquisition devices. For example, multi-mode medical images may include a T1-weighted image, a T2-weighted image, a CT image, and other medical images.

In some embodiments, the system includes one or more computer devices 110 and one or more medical image acquisition devices 120. The embodiments of this application do not limit the number of computer devices 110 and the number of medical image acquisition devices 120.

The medical image acquisition device 120 and the computer device 110 are connected through a communication network. In some embodiments, the communication network may be a wired network or a wireless network.

In some embodiments, the wired network or the wireless network uses standard communication technologies and/or protocols. The network is generally the Internet, and may also be any network, including but not limited to any combination of the Local region Network (LAN), the Metropolitan region Network (MAN), the Wide region Network (WAN), the mobile, wired or wireless network, a private network, or a virtual private network. In some embodiments, data of network exchange is represented by using techniques and/or formats including Hyper Text Mark-up Language (HTML), Extensible Markup Language (XML), etc. In addition, all or some links may also be encrypted by using conventional encryption techniques such as Secure Socket Layer (SSL), Transport Layer Security (TLS), Virtual Private Network (VPN), and Internet Protocol Security (IPsec). In some other embodiments, the data communication technology may also be replaced or supplemented with customized and/or proprietary data communication technologies. No limitation is made in this application.

FIG. 2 is a flowchart of an image processing method for a medical image according to an exemplary embodiment of this application. The method is executed by a computer device which may be implemented as the server as shown in FIG. 1. As shown in FIG. 2, the image processing method for a medical image includes the following steps:

Step 210: Call a first coding network in an image processing model to code a first sample image, to obtain a first feature map of the first sample image. The first sample image is a sample medical image of a first mode of a target medical object.

In the embodiment of this application, for a medical image, the specified type region tag may be used for representing lesion information in the first sample image. The lesion information may include the position and shape of the lesion in the first sample image and other information.

The sample image (including a first sample image and a second sample image) in the embodiment of this application may be a medical image obtained by a medical image acquisition device, such as the medical image acquisition device as shown in FIG. 1. Alternatively, the sample image may be obtained based on medical image data stored in a database. Schematically, the sample image involved in the embodiment of this application may be obtained based on image data in a public data set MyoPS20, which is composed of multiple sequence myocardial cases CMR, including bSSFP images, T2-weighted images, and LGE images of 45 cases, 25 of which are tagged. For an original CMR sequence of each patient, each bSSFP image is composed of 8-12 slices with an in-plane resolution of 1.25×1.25 mm and a slice thickness of 8-13 mm. Each T2-weighted image is composed of 3-7 slices with an in-plane resolution of 1.35×1.35 mm and a slice thickness of 12-20 mm. Each LGE image is composed of 10-18 slices with an in-plane resolution of 0.75×0.75 mm and a slice thickness of 5 mm. The above images are aligned to a common space and re-sampled to the same spatial resolution to obtain the sample images in this application.

The tag image of the first sample image may include other lesion regions of a lower resolution in the first sample image. Schematically, taking the first sample image being a T2-weighted image of a target medical object as an example, the lesion region of a higher resolution is the myocardial edema region. If the target medical object of the T2-weighted image corresponds to a myocardial scar, the tag image of the T2-weighted image may include a myocardial scarring region tag in addition to the myocardial edema region tag. Correspondingly, when the first sample image is an LGE image of the target medical object, the lesion region of a higher resolution is a myocardial scarring region, the tag image of the LGE image includes the myocardial edema region tag in addition to the myocardial scarring region tag. That is, the tag images corresponding to the medical images of different modes of the same target medical object are the same.

The mode of the sample medical image is used for indicating a manner of obtaining the medical image. Schematically, the sample medical image of the first mode may be the T2-weighted image, or the sample medical image of the first mode may also be the LEG image, or the sample medical image of the first mode may also be the medical image acquired in any other medical image acquisition manner.

Step 220: Call a decoding network in the image processing model to perform decoding based on the first feature map, to obtain a predictive segmentation image of the first sample image. The predictive segmentation image is used for indicating at least one predicted specified type region.

In some embodiments, the number of predicted specified type regions in the predictive segmentation image is equal to the number of specified tag regions in the tag image. Schematically, the predicted specified type region may be a lesion region in the first sample image predicted based on the processing by the first coding network and the decoding network.

Step 230: Call a generative network in the image processing model to generate a predictive generation image based on the first feature map. The predictive generation image is a prediction image of a second mode of the first sample image.

The first mode to which the first sample image belongs is different from the second mode to which the predictive generation image belongs.

Step 240: Train the image processing model based on a difference between the predictive segmentation image and a tag image and a difference between the predictive generation image and a second sample image. The second sample image is a sample medical image of a second mode of the target medical object. The tag image corresponds to the target medical object and is used for indicating an image of the at least one specified type region.

The computer device obtains different sample medical images of the first mode as the first sample image, and iteratively executes step 210 to step 240: performing iterative update on a parameter in the image processing model based on the difference between the predictive segmentation image of each first sample image and the tag image and the difference between the predictive generation image and the second sample image, until a training completion condition is met. The training completion condition includes: the image processing model converges, the number of iterations reaches a number threshold, and so on.

The trained image processing model may be configured to perform medical image segmentation on the inputted target medical image of the first mode, to obtain a specified type region in the target medical image, and/or generate a medical image of the second mode of the target medical image.

In conclusion, according to the image processing method for a medical image provided by the embodiments of this application, by obtaining a sample medical image of a multi-mode of a target medical object and a tag image corresponding to the target medical image and including a specified type region tag, generating a predictive segmentation image and a predictive generation image based on a first sample image in the sample medical image of the multi-mode, and training an image processing module including a first coding network, a decoding network and a generative network based on a difference between the predictive segmentation image and the tag image and a difference between the predictive generation image and a second sample image of the target medical object, the trained image processing model may obtain features of a medical image of a multi-mode based on a medical image of a single mode, so that information included in the obtained medical image segmentation result is relatively comprehensive, improving the segmentation result of the medical image.

Furthermore, medical images of other modes can be generated by the trained image processing model based on the medical image of the single mode, so that the image missing problem in the medical image analysis process is solved.

In the solution described in the embodiment of this application, the image processing model is obtained by training the multi-mode medical sample images of the same target medical object and the tag image corresponding to the target medical object, which may improve the medical image segmentation effect of the image processing model and solve the image missing problem in the medical image analysis process. The application scenarios of the above solution include, but are not limited to, the following scenarios:

1) Myocardial Infarction Diagnosis and Treatment Scenario:

The assessment of myocardial viability is crucial for the diagnosis and treatment management of patients with myocardial infarction. In practical applications, Cardiac Magnetic Resonance (CMR) images of the heart corresponding to the imaging sequence may be obtained through the CMR imaging technology, to provide anatomical and functional information of the heart. Different imaging sequences may image and provide information of different features of the heart, including a Delayed Gadolinium-Enhanced (LGE) images displaying myocardial infarction regions, a T2-weighted image highlighting the myocardial edema or myocardial ischemic injury, and a Balanced Steady-state Free Precession (bSSFP) sequence image having the ability of capturing cardiac motion and showing clear boundaries. These multi-sequence CMR images may provide rich and reliable information about myocardial pathology and morphology, and help the doctors in diagnosis and treatment planning. However, in a single-mode scenario, the information of the heart that may be obtained based on a single-mode medical image is limited. For example, when only the T2-weighted image exists, clear myocardial edema or myocardial ischemic injury may be obtained only based on the T2-weighted image, and it is difficult to obtain information on the myocardial infarction regions (myocardial scars). When only the LGE image exists, only a relatively clear myocardial infarction region may be obtained, and it is difficult to obtain information on myocardial edema or myocardial ischemia injury. In this case, the respective image processing models of the T2-weighted image and the LGE image obtained based on the image processing method for a medical image provided by the embodiment of this application, that is, the sample medical image of the T2-weighted mode is obtained as the image processing model obtained by training the first sample image, and the sample medical image of the LGE mode is obtained as the image processing model obtained by training the first sample image, the T2-weighted image is inputted into the image processing model of the T2-weighted mode, to obtain a segmentation image containing the myocardial scarring region and myocardial edema (or myocardial ischemic injury), and/or T2-weighted image corresponds to the LGE image. Alternatively, the LGE image is inputted into the image processing model corresponding to the LGE mode, to obtain a segmentation image including the myocardial scarring region and myocardial edema (or myocardial ischemia injury), and/or the T2-weighted image corresponding to the LGE image.

2) Medical Image Lesion Judgment Scenario:

In the medical field, medical staff often determines a lesion region of an organ through a medical image obtained by a medical image acquisition device, for example, checking the lesion on the stomach to confirm the gastric ulcer; confirming lung tumor; and confirming brain tumors, etc. In the scenarios above, image processing models corresponding to the scenarios may be obtained through the image processing method for a medical image provided by this application to determine the position and shape of the lesion in the organ and other information, for example, the lesion position, shape, and size of the gastric ulcer in the stomach are determined, so that the medical staff may allocate medical resources based on the position, shape, and size of the lesion. Therefore, based on the image processing model obtained by the image processing method for a medical image provided by this application, the segmentation accuracy of medical image may be improved, and the accuracy of lesion judgment may be further improved, to realize rational allocation of medical resources.

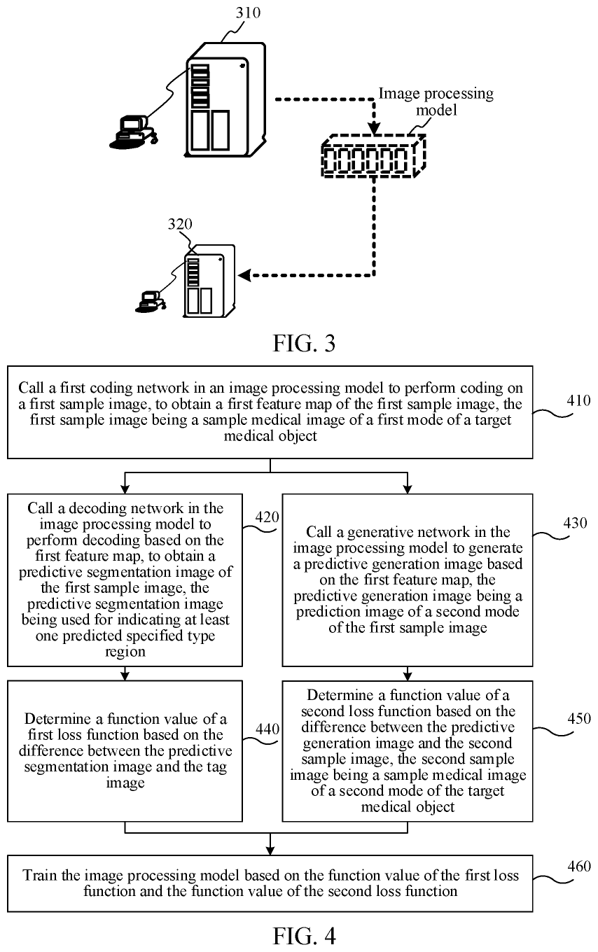

The solution involved in this application includes an image processing model generation stage and an image processing stage. FIG. 3 is a frame diagram of image processing model generation and image processing according to an exemplary embodiment. As shown in FIG. 3, at the image processing model generation stage, an image processing model generation device 310 obtains an image processing model through a preset training sample dataset (including a sample medical image of a first mode and a tag image of a target medical object corresponding to the sample medical image). An image processing model is then generated based on the image processing model. At the image processing stage, an image processing device 320 processes the inputted target medical image of the first mode based on the image processing model, to obtain an image segmentation result of the target medical image of the first mode. The image segmentation result may include a disease region annotation that may be obtained in medical images of multiple modes by the medical object corresponding to the target medical image, for example, determining the position and shape of at least one lesion in the medical object corresponding to the target medical image and other information, and/or, processing the inputted target medical image of the first mode, to obtain an image generation result of the target medical image of the first mode, and generating a medical image of a second mode of the medical object corresponding to the target medical image of the first mode to solve the image missing problem and make the image segmentation result interpretable.

In a possible implementation, in a case of applying the image processing model, if it is necessary to perform image segmentation on the target medical image, a first coding network and a decoding network in the image processing model may be used, or an image segmentation model may be reconstructed based on the first coding network and the decoding network in the image processing model, and parameters in the image segmentation model are consistent with parameters of the first coding network and the decoding network in the image processing model. In another possible implementation, in a case of applying the image processing model, if it is necessary to generate a corresponding medical image of a second mode based on the inputted target medical image of the first mode, the first coding network and a generative network in the image processing model may be used, or an image generation model may be reconstructed based on the first coding network and the generative network in the image processing model, and parameters in the image generation model are consistent with parameters of the first coding network and the generative network in the image processing model.

The image processing model generation device 310 and the image processing device 320 may be computer devices, for example, the computer devices may be fixed computer devices such as personal computers and servers, or the computer devices may also be mobile computer devices such as a tablet computer and an e-book reader.

In some embodiments, the image processing model generation device 310 and the image processing device 320 may be the same device, or the image processing model generation device 310 and the image processing device 320 may also be different devices. Moreover, when the image processing model generation device 310 and the image processing device 320 are different devices, the image processing model generation device 310 and the image processing device 320 may be the same type of device, for example, the image processing model generation device 310 and the image processing device 320 may be servers. Alternatively, the image processing model generation device 310 and the image processing device 320 may also be different types of devices, for example, the image processing device 320 may be a personal computer or a terminal, while the image processing model generation device 310 may be a server or the like. The embodiment of this application does not limit the specific types of the image processing model generation device 310 and the image processing device 320.

FIG. 4 is a flowchart of an image processing method for a medical image according to an exemplary embodiment of this application. The method is executed by a computer device which may be implemented as the server as shown in FIG. 1. As shown in FIG. 4, the image processing method for a medical image includes the following steps:

Step 410: Call a first coding network in an image processing model to code a first sample image, to obtain a first feature map of the first sample image. The first sample image is a sample medical image of a first mode of a target medical object.

Step 420: Call a decoding network in the image processing model to perform decoding based on the first feature map, to obtain a predictive segmentation image of the first sample image. The predictive segmentation image is used for indicating at least one predicted specified type region.

Step 430: Call a generative network in the image processing model to generate a predictive generation image based on the first feature map. The predictive generation image is a prediction image of a second mode of the first sample image.

Step 440: Determine a function value of a first loss function based on the difference between the predictive segmentation image and the tag image.

In the embodiment of this application, a function value of a first branch function of the first loss function is determined based on a similarity between the predictive segmentation image and the tag image.

A function value of a second branch function of the first loss function is determined based on at least one specified type region in the predictive segmentation image and at least one specified type region tag in the tag image.

The function value of the first loss function is determined based on the function value of the first branch function and the function value of the second branch function.

In a possible implementation, the process of determining a function value of a first branch function of the first loss function based on a similarity between the predictive segmentation image and the tag image may include: obtaining a weight value corresponding to each division region in the predictive segmentation image, the each division region in the predictive segmentation image including the at least one specified type region; and determining the function value of the first branch function of the first loss function based on the weight value corresponding to each division region in the predictive segmentation image and a similarity between the each division region in the predictive segmentation image and each division region in the tag image.

Each division region includes a specified type region. Furthermore, each division region may also include at least one type of division region other than the specified type region, such as a background region and a normal region.

Since in the same medical image, there is a large difference in the area of the medical image occupied by different division regions, that is, there is an extremely unbalanced state of positive and negative samples. Therefore, in order to balance the importance of positive and negative samples, a Focal Dice loss L_{FDL} may be used as the first branch function in the first loss function. In the first branch function, different division regions have different weights correspondingly, so that the division regions that are difficult to segment may obtain higher weights in the segmentation process, so that the network may focus on learning harder categories. The first branch function of the first loss function may be expressed as:

$${L}_{F D L} = {\sum }_{t} {ω}_{t} ( 1 - {Dice}_{t}^{\frac{1}{β}} )$$

ω represents the weight of the division region t, and the parameter 1/β represents the power of Diceₜ of the division region t, schematically β=2.

The Dice coefficient is a metric function used for evaluating the similarity of two samples, and the value ranges from 0 to 1. The larger the value is, the more similar it is. In the embodiment of this application, the similarity between the two samples is reflected as the similarity between the predictive segmentation image and the tag image, and is further reflected as the similarity between each division region in the predictive segmentation image and the division region in the tag image. Schematically, the division regions in the predictive image may include a lesion region, a normal region, and a background region. Generally speaking, the area of the background region accounts for a larger proportion of the area of the medical image, the area of the normal region accounts for a second large proportion of the area of the medical image, and the area of the lesion region accounts for the smallest proportion of the area of the medical image. In order to make the decoding network pay more attention to the lesion region, in the first branch function, a weight value of the lesion region may be set to the maximum, a weight value of the normal region is the second largest, and a weight value of the background region is the smallest. In some embodiments, the value of the weight value is inversely proportional to the area of each division region in the area of the medical image. Alternatively, the value of the weight value corresponds to the type of each division region. For example, taking the medical image being a myocardial image as an example, the corresponding lesions include myocardial scar and myocardial edema, the weight set of each division region in the predictive segmentation image may be set as ω={1, 1, 1, 0.5}, where the weight of the division region of the myocardial scar is 1, the weight of the division region of myocardial edema is 1, the weight of the division region of normal myocardium is 1, and the weight of the division region of background is 0.5. It is to be illustrated that the setting of the weights above is only illustrative, and this application does not limit the weight values respectively corresponding to the division regions and the relationship between the weight values.

In the embodiment of this application, a mean square error loss function may be adopted to quantify a difference between the position of at least one specified position region predicted in the predictive segmentation image and the position of at least one specified type region in the tag image. The second branch function of the first loss function may be expressed as:

$${L}_{m s e} = \frac{1}{H \times W} {\sum }_{i = 1}^{H} {\sum }_{j = 1}^{W} {( {P}_{t} ( i , j ) - {G}_{t} ( i , j ) )}^{2}$$

H and W represent a width and a height of the predictive segmentation image (tag image), respectively, and Pt and Gt represent a predictive position and a tag image position of the specified type region t, respectively. In some embodiments, the specified type region in the tag image may include at least one of a lesion region, a normal region, and a background region.

In the embodiment of this application, the sum of the function value of the first branch function and the function value of the second branch function is obtained as the function value of the first loss function. Furthermore, in order to balance the effects of the first branch function and the second branch function, different weight values may be set for the first branch function and the second branch function. Schematically, the first loss function may be expressed as:

L_{seg}—L_{FDL}+λLₘₛₑ

λ represents a weight value of the second branch function relative to the first branch function. Schematically, the value of λ may be 100.

Step 450: Determine a function value of a second loss function based on the difference between the predictive generation image and the second sample image. The second sample image is a sample medical image of a second mode of the target medical object.

Schematically, the second loss function may be represented as:

$${L}_{r e c} = \frac{1}{H \times W} {\sum }_{i = 1}^{H} {\sum }_{j = 1}^{W} {( {x}^{′ ( i , j )} - G ( x ) ( i , j ) )}^{2}$$

x identifies the predictive generation image, x′ represents the sample medical image of the second mode of the target medical object, H and W represent the width and the height of the predictive generation image (the sample medical image of the second mode), respectively.

Step 460: Train the image processing model based on the function value of the first loss function and the function value of the second loss function.

In the embodiment of this application, the first loss function and the second loss function perform parameter update on different network combinations in the image processing model.

In some embodiments, a parameter of the first coding network and a parameter of the decoding network are updated based on the function value of the first loss function.

The parameter of the first coding network and a parameter of the generative network are updated based on the function value of the second loss function.

That is, both the function value of the first loss function and the function value of the second loss function may guide the parameter update of the first coding network in the image processing model. Therefore, the generative network is configured to assist the generation of an image segmentation model (a model including a coding network and a decoding network). In other words, the decoding network is configured to assist the generation of an image generation model (a model including a coding network and a generative network).

In the embodiment of this application, a third loss function may also be introduced to train the image processing model. The third loss function is used for indicating the authenticity of the predictive generation image. The process may be implemented as:

calling a discriminator to discriminate the predictive generation image, to obtain a discrimination result of the predictive generation image; and

determining a function value of a third loss function based on the discrimination result. The discrimination result is used for indicating whether the predictive generation image is a real image or not.

Schematically, the third loss function may be represented as:

$${L}_{G A N} = {min}_{G} {max}_{D} L = {E}_{x \sim {P}_{real} ( x )} [ log D ( {x}^{′} ) ] + {E}_{x \sim {P}_{f a k e} ( x )} [ log ( 1 - D ( G ( x ) ) ) ]$$

G represents the generative network, D represents a discriminative network (the discriminator), E_{x˜P}_{ᵣₑₐₗ}₍ₓ₎ represents a real image distribution, and E_{x˜P}_{_{fake}}₍ₓ₎ represents a false image distribution.

In the above case, the training the image processing model includes: training the image processing model based on the function value of the first loss function, the function value of the second loss function, and the function value of the third loss function.

In the embodiment of this application, the parameter of the first coding network and the parameter of the generative network are updated based on the function value of the third loss function.

The discriminator may be pre-trained. Alternatively, the parameters in the discriminator may be updated based on the function value of the third loss function. In this case, the input of the discriminator also includes the sample medical image of the second mode of the target medical object, to train the discriminator. The discriminator has the effect of assisting in training the generative network to improve the quality of images generated by the generative network.

In conclusion, according to the image processing method for a medical image provided by the embodiments of this application, by obtaining a sample medical image of a multi-mode of a target medical object and a tag image corresponding to the target medical image and including a specified type region tag, generating a predictive segmentation image and a predictive generation image based on a first sample image in the sample medical image of the multi-mode, and training an image processing module including a first coding network, a decoding network and a generative network based on a difference between the predictive segmentation image and the tag image and a difference between the predictive generation image and a second sample image of the target medical object, the trained image processing model may obtain features of a medical image of a multi-mode based on a medical image of a single mode, so that information included in the obtained medical image segmentation result is relatively comprehensive, improving the segmentation result of the medical image.

Furthermore, medical images of other modes can be generated by the trained image processing model based on the medical image of the single mode, so that the image missing problem in the medical image analysis process is solved.

In some embodiments, in order to improve the accuracy of model training and reduce errors caused by the class imbalance problem, a priori constraint image of the image processing model may be obtained based on the third sample image. The priori constraint image is used for indicating a predicted position of the target medical object in the sample image. The third sample image may be one of the first sample image and the second sample image, or the third sample image may also be a sample medical image of a third mode of the target medical image. For the CMR images obtained by cardiac magnetic resonance, the third sample image may be a bSSFP image having the ability of capturing cardiac motion and showing clear boundaries. Compared with the T2-weighted image and the LGE image, a more accurate myocardium position and shape may be obtained based on the bSSFP image. Therefore, the priori constraint image obtained based on the bSSFP image is more accurate in predicting the position of the target medical object in the sample image.

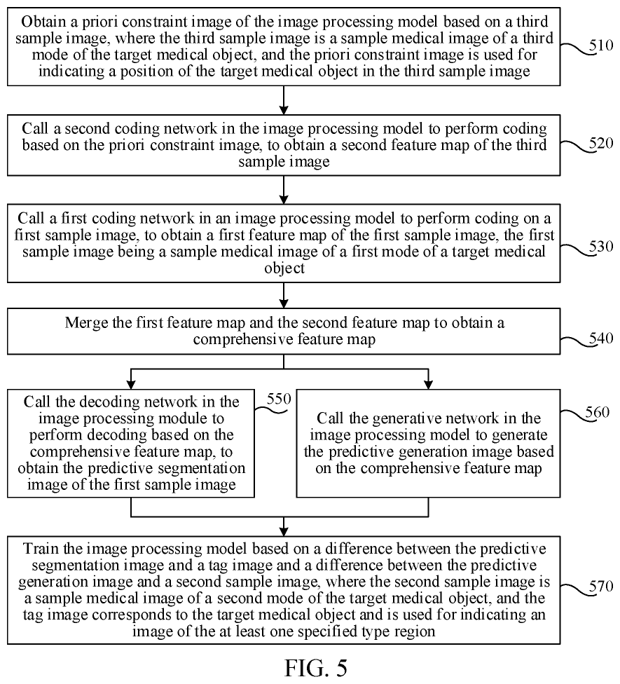

In the above case, based on the image processing method for a medical image shown in the embodiment as shown in FIG. 4, FIG. 5 is a flowchart of an image processing method for a medical image according to an exemplary embodiment of this application. As shown in FIG. 5, the method includes the following steps:

Step 510: Obtain a priori constraint image of the image processing model based on a third sample image. The third sample image is a sample medical image of a third mode of the target medical object. The priori constraint image is used for indicating a position of the target medical object in the third sample image.

The position of the target medical object indicated by the priori constraint image in the third sample image may indicate the position of the target medical image in other sample images (including the first sample image and the second sample image).

In the embodiment of this application, a semantic segmentation network (U-Net) may be called to process the third sample image to obtain a priori constraint object of the image processing model.

The semantic segmentation network is trained based on a sample image set. The sample image set includes a fourth sample image and an approximate mark of the fourth sample image. The fourth sample image is a sample medical image of a third mode of other medical objects. The approximate mark is used for indicating a position of the other medical object in the fourth sample image.

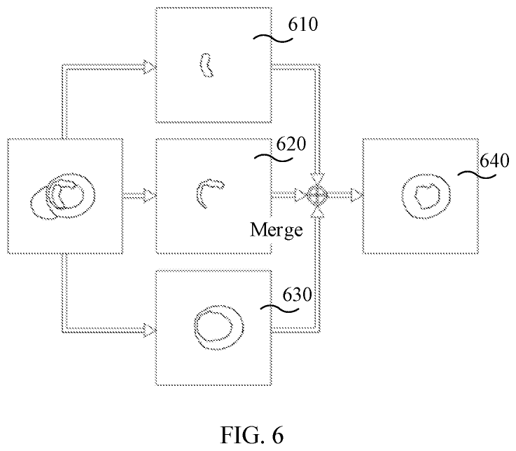

Taking the type of other medical objects being the myocardium as an example, in the myocardial medical image, the myocardial edema region and the myocardial scarring region account for a relatively low proportion of the medical image, and the corresponding regions do not overlap. Therefore, images of the normal myocardial region, the myocardial edema region and the myocardial scarring region are merged to obtain as approximate marks of the medical image. FIG. 6 is a schematic composite diagram of an approximate mark according to an exemplary embodiment of this application. As shown in FIG. 6, a myocardial edema region 610 and a myocardial scarring region 620 are extracted from the tag image, and are combined with a normal myocardial region 630 to generate an approximate mark 640. The approximate mark is obtained as a tag of the first sample object, and the semantic segmentation image is trained, so that the trained semantic segmentation image may process the inputted third sample image, and the priori constraint image of the third sample image is obtained.

Step 520: Call a second coding network in the image processing model to perform coding based on the priori constraint image, to obtain a second feature map of the third sample image.

In the embodiment of this application, the image processing model may also include a second coding network. In order to alleviate the over-fitting problem caused by excessive network parameters, in the embodiment of this application, the parameters of the second coding network may be set to be consistent with those of the first coding network. That is, the parameters in the second coding network share the weights of the parameters in the first coding network.

In some embodiments, in order to further reduce the influence of the background region on model training, after obtaining the priori constraint image, the priori constraint image may be cropped based on the position of the target medical object. A second coding network in the image processing model is then called to code the cropped priori constraint image, to obtain a second feature map of the third sample image.

It is adapted to the size of the priori constraint image, other sample images (including the first sample image and the second sample image) are preprocessed, that is, other sample images are cropped, and it is ensured that the position of the target medical object in other image samples is similar to the position of the target medical object in the priori constraint image within a specified error range. In some embodiments, it is ensured that the position of the target medical object in other image samples and the position of the target medical object in the priori constraint image are at the center of the image within the specified error range. Taking the target medical object being myocardium as an example, for the priori constraint image, since the myocardium is a circular symmetrical tissue, the priori constraint image is cropped according to the center of the obtained approximate mark. Other sample images may be cropped according to the position of the specified type region in the tag image, and may also be cropped according to the center of the approximate mark. This application does not limit the basis for cropping other sample images.

In some embodiments, since the data ranges of different cases are quite different, the cropped priori image may be further processed, for example, the data distribution is further balanced after setting the window level and a window width uniformly by applying a histogram equalization and random gamma method.

In addition, before processing the sample image, data enhancement processing may be performed on the sample image. The data enhancement processing method includes methods such as random rotation, random cropping, and random scaling.

Step 530: Call a first coding network in an image processing model to code a first sample image, to obtain a first feature map of the first sample image. The first sample image is a sample medical image of a first mode of a target medical object.

If the image inputted into the second coding network is a priori constraint image, the first sample image is an original first sample image. If the image inputted into the second coding network is the cropped priori constraint image, the first sample image is the cropped first sample image. That is, the size of the image inputted into each coding network remains the same.

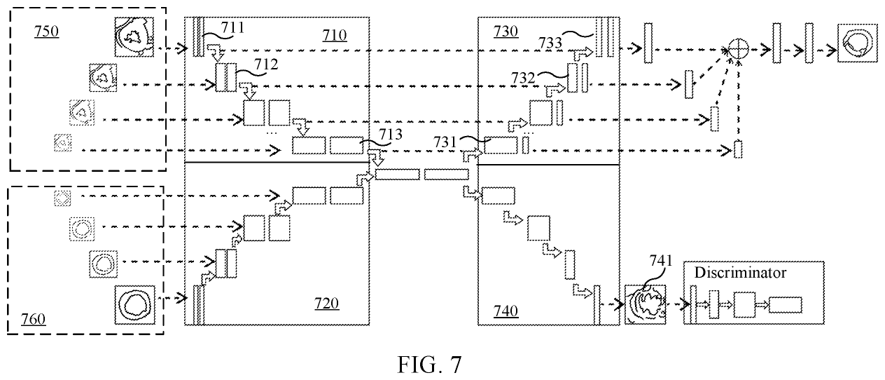

In the embodiment of this application, in order to make the generated predictive segmentation image and/or predictive generation image more accurate, the image processing model may be built based on a butterfly network architecture. A first coding network in the butterfly network includes N coding layers, and the N coding layers are connected in pairs. The decoding network in the butterfly network includes N decoding layers, and the N decoding layers are connected in pairs. The N decoding layers in the decoding network have one-to-one correspondence to the N coding layers in the first coding network. FIG. 7 is a schematic structural diagram of an image processing model according to an exemplary embodiment of this application. As Shown in FIG. 7, the first coding network 710 includes N coding layers, and the decoding network 730 includes N decoding layers. A first coding layer 711 in the first coding network 710 has one-to-one correspondence to an N^{th} coding layer 733 in the decoding network 730, and a second coding layer 712 in the first coding network 710 has one-to-one correspondence to an N−1^{th} decoding layer 732 in the decoding network 730. By parity of reasoning, an N^{th} coding layer 713 in the first coding network 710 has one-to-one correspondence to a first decoding layer 731 in the decoding network 730. In some embodiments, as shown in FIG. 7, the image processing model includes a second coding layer 720. The second coding network 720 may also include N coding layers, and the N coding layers in the second coding layer are connected in pairs.

In the embodiment of this application, the N coding layers are connected in pairs, which may mean that two adjacent coding layers are connected.

When the image processing model is a model built based on the butterfly network architecture as shown in FIG. 7, the process of calling a first coding network in an image processing model to code a first sample image, to obtain a first feature map corresponding to the first sample image may be implemented as:

obtaining a first image pyramid of the first sample image, the first image pyramid being an image set obtained by down-sampling the first sample image according to a specified gradient, and the first image pyramid including N first to-be-processed images; and

respectively inputting the N first to-be-processed images to corresponding coding layers, and coding the N first to-be-processed images to obtain N first feature maps of the first sample image.

In response to a target coding layer being not a first coding layer in the N coding layers, an input of the target coding layer further includes a first feature map outputted by a previous coding layer.

There are differences in the resolutions of the first to-be-processed images in the first image pyramid, each image in the first image pyramid corresponds to a side input path, and each side input path is used for inputting the corresponding first to-be-processed image into the corresponding coding layer in the first coding network. As shown in FIG. 7, the first image pyramid 750 includes N first to-be-processed images. Each first to-be-processed image corresponds to a side input path. For the non-first coding layer in the first coding network 710, an input includes the first to-be-processed image inputted by the corresponding side input path, and the first feature map outputted by the previous coding layer of the coding layer.

Adaptively, taking the image inputted into the second coding network 720 being a cropped priori constraint image as an example, for the second coding network 720, the process of obtaining the second feature map includes: obtaining a second image pyramid corresponding to the cropped priori constraint image, the second image pyramid being an image set obtained by down-sampling the cropped priori constraint image according to the specified gradient, and the second image pyramid including N second to-be-processed images;

respectively inputting the N second to-be-processed images to corresponding coding layers in the second coding network, and coding the N second to-be-processed images to obtain N coding results of the cropped priori constraint image; and

merging the N coding results to obtain a second feature map of the cropped priori constraint image.

When the coding layer in the second coding network being not a first coding layer, an input of the coding layer further includes a coding result outputted by the previous coding layer.

There are differences in the resolutions of the second to-be-processed images in the second image pyramid, each second to-be-processed image in the second image pyramid corresponds to a side input path, and each side input path is used for inputting the corresponding second to-be-processed image into the corresponding coding layer in the second coding network. As shown in FIG. 7, the second image pyramid 760 includes N second to-be-processed images. Each second to-be-processed image corresponds to a side input path. For the non-first coding layer in the second coding network 720, an input includes the second to-be-processed image inputted by the corresponding side input path, and the coding result outputted by the previous coding layer of the coding layer.

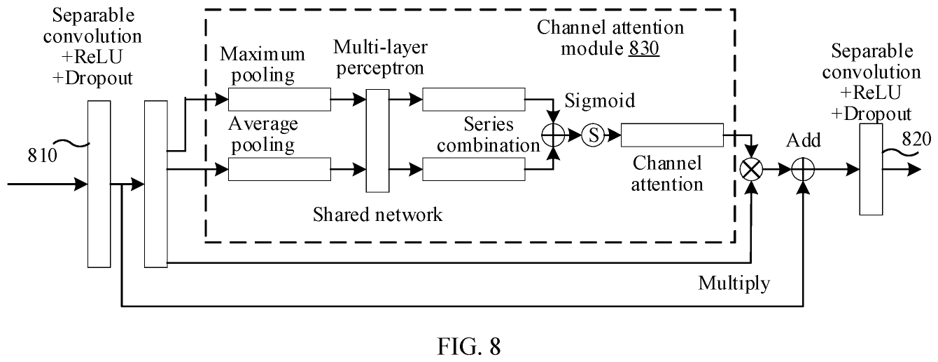

In the embodiment of this application, the structure of the coding layer in the coding network (the first coding network/the second coding network) may use a two-layer convolution layer structure of “3×3 separable convolution+ReLU activation function+Dropout operation”. FIG. 8 is a schematic structural diagram of a coding layer according to an exemplary embodiment of this application. As shown in FIG. 8, the coding layer in the coding network includes a convolution layer 810 and a convolution layer 820. A channel attention module 830 is added between two convolution layers in the way of residual connection. In the channel attention module 830, a feature map obtained by the convolution layer 810 is compressed in the spatial dimension by using maximum pooling and average pooling. A shared network is composed of a Multi-Layer Perceptron (MLP). A channel attention feature map is obtained by performing perception, series combination and activation function processing on the compressed feature map. The channel attention feature map is multiplied by an input of the channel attention module, and an output of the convolution layer 810 of the coding network is added to form a residual structure to obtain an intermediate feature map, which is followed by a convolution layer 820 for down-sampling the intermediate feature map by using the convolution layer with a specified step size to obtain a feature map (a first feature map/coding result) outputted by the convolution layer 820. Schematically, the specified step size may be 2. In some embodiments, in order to better extract the features of the inputted image, the convolution layer in the coding network may be replaced by a depth separable convolution layer.

Step 540: Merge the first feature map and the second feature map to obtain a comprehensive feature map.

When the image processing model is a model built based on the butterfly network architecture as shown in FIG. 7, the comprehensive feature map is a result of merging the first feature map outputted by the N^{th} coding layer of the first coding network 710 and the second feature map outputted by the second coding network 720.

Step 550: Call the decoding network in the image processing model to perform decoding based on the comprehensive feature map, to obtain the predictive segmentation image of the first sample image.

When the image processing model is a model built based on the butterfly network architecture as shown in FIG. 7, the process of calling the decoding network in the image processing model to perform decoding based on the comprehensive feature map, to obtain the predictive segmentation image of the first sample image may be implemented as:

respectively inputting the N first feature maps to corresponding decoding layers in the decoding network, and decoding the N first feature maps to obtain N decoding results, the N decoding results having a same resolution; and

merging the N decoding results to obtain the predictive segmentation image of the first sample image.

In response to a target decoding layer being not a first decoding layer in the N decoding layers, an input of the target decoding layer further includes a decoding result outputted by a previous decoding layer.

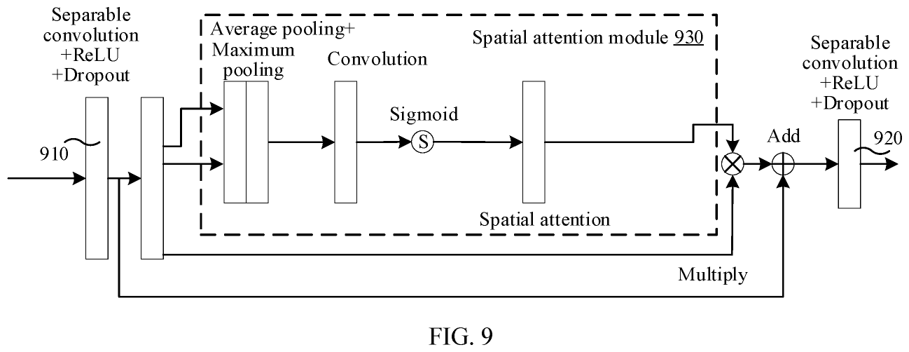

In the embodiment of this application, the structure of the decoding layer in the decoding network may use a two-layer convolution layer structure of “3×3 separable convolution+ReLU activation function+Dropout operation”. FIG. 9 is a schematic structural diagram of a decoding layer according to an exemplary embodiment of this application. As shown in FIG. 9, the decoding layer in the decoding network includes a convolution layer 910 and a convolution layer 920. A spatial attention module 930 is added between two convolution layers in the way of residual connection. The spatial attention module 930 mainly focuses on position information. In the spatial attention module 930, a feature map is obtained by processing in the channel dimension using maximum pooling and average pooling, and then cascaded and convoluted through a convolution layer, and processed by activation function processing to obtain a spatial attention feature map. The spatial attention feature map is multiplied by an input of the spatial attention module, and an output of the convolution layer 910 of the decoding network is added to form a residual structure to obtain an intermediate feature map, which is followed by a convolution layer 920 for down-sampling the intermediate feature map by using the convolution layer of a specified step size, to obtain a decoding result outputted by the convolution layer 920.

Step 560: Call a generative network in the image processing model to generate the predictive generation image based on the comprehensive feature map.

As shown in FIG. 7, the image processing model may include a generative network 740, configured to generate a predictive generation image 741 based on the comprehensive feature map.

Step 570: Train the image processing model based on a difference between the predictive segmentation image and a tag image and a difference between the predictive generation image and a second sample image. The second sample image is a sample medical image of a second mode of the target medical object. The tag image corresponds to the target medical object and is used for indicating an image of the at least one specified type region.

The image processing model of the butterfly network architecture provided by this application may combine deep semantic information and stratigraphic position information, to reduce the disappearance of gradients while ensuring a network width. On the other hand, through the supervision of multi-scale and multi-resolution input images, more image features may be obtained, and then better image segmentation effects and/or image generation effects may be obtained.

In conclusion, according to the image processing method for a medical image provided by the embodiments of this application, by obtaining a sample medical image of a multi-mode of a target medical object and a tag image corresponding to the target medical image and including a specified type region tag, generating a predictive segmentation image and a predictive generation image based on a first sample image in the sample medical image of the multi-mode, and training an image processing module including a first coding network, a decoding network and a generative network based on a difference between the predictive segmentation image and the tag image and a difference between the predictive generation image and a second sample image of the target medical object, the trained image processing model may obtain features of a medical image of a multi-mode based on a medical image of a single mode, so that information included in the obtained medical image segmentation result is relatively comprehensive, improving the segmentation result of the medical image.

Furthermore, medical images of other modes can be generated by the trained image processing model based on the medical image of the single mode, so that the image missing problem in the medical image analysis process is solved.

In a possible implementation, in a case of training the image processing model, the training results of the two image processing models may be combined to obtain a final image processing model. Schematically, the input of the first image processing model is a first sample image. The first sample image is a sample medical image of a first mode of the target medical object. The first image processing model is trained by taking the tag image of the target medical object and the second sample image as tags to obtain a trained first image processing model, and the second sample image is a sample medical image of a second mode of the target medical object. The first image processing model is configured to generate a predictive segmentation image of the inputted medical image of the first mode, and/or generate a medical generation image of a second mode of the inputted medical image of the first mode. The input of the second image processing model is a second sample image. The second image processing model is trained by taking the tag image of the target medical object and the first sample image as tags to obtain a trained second image processing model. The second image processing model is configured to generate a predictive segmentation image of the inputted medical image of the second mode, and/or generate a medical generation image of a first mode of the inputted medical image of the second mode. If the input images of the two image processing models are medical images of different modes of the same medical object, the predictive segmentation images respectively processed based on the first image processing model and the second image processing model are the same, or the error is within the specified threshold range.

In some embodiments, in order to reduce network parameters, weight sharing may be performed on the parameters of the coding network and the decoding network of the first image processing model and the parameters of the coding network and the decoding network in the second image processing model. This process may be performed in the model training process, or after the model training is completed. Schematically, weight sharing may be implemented as: replacing the parameters of the coding network and the decoding network in one of the image processing models with a coding network and a decoding network of the other image processing model, or an average value of the parameters of the coding network and an average value of the parameters of the decoding network in the two image processing models are respectively replaced in the coding network and the decoding network of the two image processing models, and the manner of weight sharing is not limited in this application.

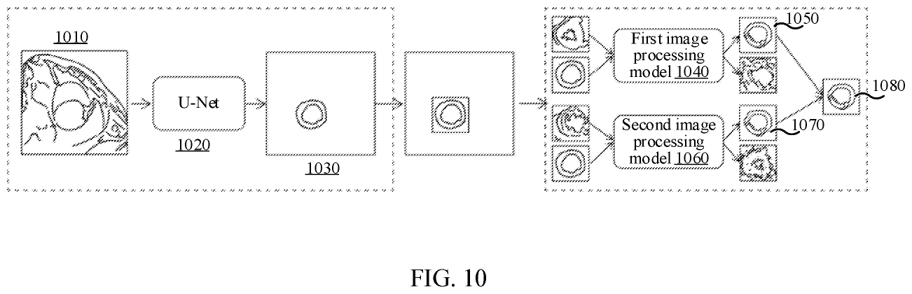

Schematically, taking the segmentation of myocardial scar and myocardial edema as an example, the application process of the image processing model generated based on this application is described. FIG. 10 is a schematic diagram of an application process of an image processing model according to an exemplary embodiment of this application. This process may be implemented in a terminal or server deployed with an image processing model, or a terminal or server deployed with an image segmentation model constructed based on the image processing model, as shown in FIG. 10. Based on the cardiac magnetic resonance technology, the CMR images of the same medical object, i.e., the bSSFP image, the T2-weighted image and the LGE images in FIG. 10 are obtained. At the first stage, a bSSFP image 1010 is inputted into a U-Net network 1020 to obtain a priori constraint image 1030 outputted by the U-Net network. The priori constraint image is used for indicating position information of the medical object in the CMR image. Based on the center position of the medical object in the priori constraint image, the priori constraint image and the T2-weighted image are cropped with the LGE image, and the cropped T2-weighted image and the 26 roped priori constraint image are inputted to a corresponding first image processing model 1040 of a T2 mode, to obtain a first predictive segmentation image 1050 outputted by the first image processing model. The first predictive segmentation image includes position information of the myocardial scar and position information of the myocardial edema. The cropped LGE image and the cropped priori constraint image are inputted into a corresponding second image processing model 1060 of the LGE mode, to obtain a second predictive segmentation image 1070 outputted by the second image processing model. In order to further improve the accuracy of the predictive segmentation image, the first predictive segmentation image and the second predictive segmentation image are merged to obtain a segmentation image 1080 of myocardial scar and myocardial edema of the medical object. In addition, when the process is implemented in the terminal or server deployed with the image processing model, a corresponding LGE image may be generated based on the T2-weighted image, and a corresponding T2-weighted image may be generated based on the LGE image.

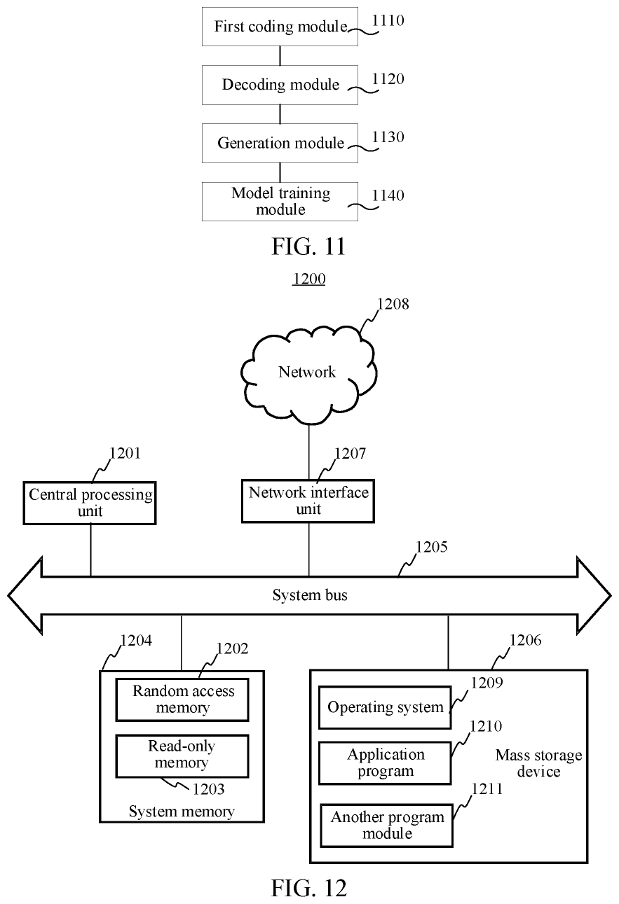

FIG. 11 is a block diagram of an image processing apparatus for a medical image according to an exemplary embodiment of this application. As shown in FIG. 11, the apparatus includes a first coding module 1110, a decoding module 1120, a generation module 1130, and a model training module 1140.

The first coding module 1110 is configured to call a first coding network in an image processing model to code a first sample image, to obtain a first feature map of the first sample image. The first sample image is a sample medical image of a first mode of a target medical object.

The decoding module 1120 is configured to call a decoding network in the image processing model to perform decoding based on the first feature map, to obtain a predictive segmentation image of the first sample image. The predictive segmentation image is used for indicating at least one predicted specified type region.

The generation module 1130 is configured to call a generative network in the image processing model to generate a predictive generation image based on the first feature map. The predictive generation image is a prediction image of a second mode of the first sample image.

The model training module 1140 is configured to train the image processing model based on a difference between the predictive segmentation image and a tag image and a difference between the predictive generation image and a second sample image. The second sample image is a sample medical image of a second mode of the target medical object. The tag image corresponds to the target medical object and is used for indicating an image of the at least one specified type region.

In a possible implementation, the model training module 1140 includes a first determining submodule, a second determining submodule, and a model training submodule.

The first determining submodule is configured to determine a function value of a first loss function based on the difference between the predictive segmentation image and the tag image.

The second determining submodule is configured to determine a function value of a second loss function based on the difference between the predictive generation image and the second sample image.

The model training submodule is configured to train the image processing model based on the function value of the first loss function and the function value of the second loss function.

In a possible implementation, the model training submodule is configured to update a parameter of the first coding network and a parameter of the decoding network based on the function value of the first loss function; and

update the parameter of the first coding network and a parameter of the generative network based on the function value of the second loss function.

In a possible implementation, the first determining submodule includes a first determining unit, a second determining unit, and a third determining unit.

The first determining unit is configured to determine a function value of a first branch function of the first loss function based on a similarity between the predictive segmentation image and the tag image.

The second determining unit is configured to determine a function value of a second branch function of the first loss function based on a position of at least one specified type region predicted in the predictive segmentation image and a position of at least one specified type region in the tag image.

The third determining unit is configured to determine the function value of the first loss function based on the function value of the first branch function and the function value of the second branch function.

In a possible implementation, the first determining unit is configured to obtain a weight value corresponding to each division region in the predictive segmentation image, the each division region in the predictive segmentation image including the at least one specified type region; and

determine the function value of the first branch function of the first loss function based on the weight value corresponding to each division region in the predictive segmentation image and a similarity between the each division region in the predictive segmentation image and each division region in the tag image.

In a possible implementation, the apparatus further includes a discriminating module, a third determining module, and the model training module 1140.

The discriminating module is configured to call a discriminator to discriminate the predictive generation image, to obtain a discrimination result of the predictive generation image.

The third determining module is configured to determine a function value of a third loss function based on the discrimination result. The discrimination result is used for indicating whether the predictive generation image is a real image or not.

The model training module 1140 is configured to train the image processing model based on the function value of the first loss function, the function value of the second loss function, and the function value of the third loss function.

In a possible implementation, the first coding network includes N coding layers, and the N coding layers are connected in pairs, N≥2 and is a positive integer.

The first coding module 1110 includes a set obtaining submodule and a coding submodule.

The set obtaining submodule is configured to obtain a first image pyramid of the first sample image. The first image pyramid is an image set obtained by down-sampling the first sample image according to a specified gradient, and the first image pyramid includes N first to-be-processed images.

The coding submodule is configured to respectively input the N first to-be-processed images to corresponding coding layers, and code the N first to-be-processed images to obtain N first feature maps of the first sample image.

In response to a target coding layer being not a first coding layer in the N coding layers, an input of the target coding layer further includes a first feature map outputted by a previous coding layer.

In a possible implementation, the decoding network in the image processing model includes N decoding layers, and the N decoding layers are connected in pairs, the N decoding layers having one-to-one correspondence to the N coding layers.

The decoding module 1120 includes a decoding submodule and a merging submodule.

The decoding submodule is configured to respectively input the N first feature maps to corresponding decoding layers, and decode the N first feature maps to obtain N decoding results. The N decoding results have a same resolution.

The merging submodule is configured to merge the N decoding results to obtain the predictive segmentation image of the first sample image.

In response to a target decoding layer being not a first decoding layer in the N decoding layers, an input of the target decoding layer further includes a decoding result outputted by a previous decoding layer.

In a possible implementation, the apparatus further includes an image obtaining module, a second coding module, a merging module, the decoding module 1120, and the generation module 1130.

The image obtaining module is configured to obtain a priori constraint image of the image processing model based on a third sample image. The third sample image is a sample medical image of a third mode of the target medical object. The priori constraint image is used for indicating a position of the target medical object in the third sample image.

The second coding module is configured to call a second coding network in the image processing model to perform coding based on the priori constraint image, to obtain a second feature map of the third sample image.

The merging module is configured to merge the first feature map and the second feature map to obtain a comprehensive feature map.

The decoding module 1120 is configured to call the decoding network in the image processing model to perform decoding based on the comprehensive feature map, to obtain the predictive segmentation image of the first sample image.

The generation module 1130 is configured to call a generative network in the image processing model to generate the predictive generation image based on the comprehensive feature map.

In a possible implementation, the apparatus further includes a cropping module and the second coding module.

The cropping module is configured to crop the priori constraint image based on the position of the target medical object.

The second coding module is configured to call the second coding network in the image processing model to code the cropped priori constraint image, to obtain the second feature map of the third sample image.

In a possible implementation, the image obtaining module is configured to call a semantic segmentation network to process the third sample image, to obtain the priori constraint image of the image processing model.

In a possible implementation, a parameter in the second coding network is shared with a parameter weight in the first coding network.

In conclusion, according to the image processing apparatus for a medical image provided by the embodiments of this application, by obtaining a sample medical image of a multi-mode of a target medical object and a tag image corresponding to the target medical image and including a specified type region tag, generating a predictive segmentation image and a predictive generation image based on a first sample image in the sample medical image of the multi-mode, and training an image processing module including a first coding network, a decoding network and a generative network based on a difference between the predictive segmentation image and the tag image and a difference between the predictive generation image and a second sample image of the target medical object, the trained image processing model may obtain features of a medical image of a multi-mode based on a medical image of a single mode, so that information included in the obtained medical image segmentation result is relatively comprehensive, improving the segmentation result of the medical image.

Furthermore, medical images of other modes can be generated by the trained image processing model based on the medical image of the single mode, so that the image missing problem in the medical image analysis process is solved.

FIG. 12 is a schematic block diagram of a computer device 1200 according to an exemplary embodiment of this application. The computer device may be implemented as the server in the solution of this application. The computer device 1200 includes a Central Processing Unit (CPU) 1201, a system memory 1204 including a Random Access Memory (RAM) 1202 and a Read-Only Memory (ROM) 1203, and a system bus 1205 connecting the system memory 1204 and the CPU 1201. The computer device 1200 further includes a mass storage device 1206 configured to store an operating system 1209, an application program 1210, and another program module 1211.

The mass storage device 1206 is connected to the CPU 1201 through a mass storage controller (not shown) connected to the system bus 1205. The mass storage device 1206 and a computer-readable medium associated therewith provide non-volatile storage to the computer device 1200. That is, the mass storage device 1206 may include a computer-readable medium (not shown) such as a hard disk or a Compact Disc Read-Only Memory (CD-ROM) drive.

Generally, the computer-readable medium may include a computer storage medium and a communication medium. The computer storage medium includes volatile and non-volatile, removable and non-removable media that store information such as computer-readable instructions, data structures, program modules, or other data and that are implemented by using any method or technology. The computer storage medium includes a RAM, a ROM, an Erasable Programmable Read Only Memory (EPROM), an Electrically-Erasable Programmable Read-Only Memory (EEPROM) flash memory or other solid state storage technology, a CD-ROM, a Digital Versatile Disc (DVD) or other optical storage, a tape cartridge, a tape, a disk storage, or other magnetic storage devices. Certainly, a person skilled in art may know that the computer storage medium is not limited to the foregoing several types. The system memory 1204 and the mass storage device 1206 may be collectively referred to as a memory.

According to the embodiments of this application, the computer device 1200 may further be connected, through a network such as the Internet, to a remote computer on the network and run. That is, the computer device 1200 may be connected to a network 1208 through a network interface unit 1207 connected to the system bus 1205, or may be connected to another type of network or a remote computer system (not shown) by using a network interface unit 1207.

The memory also includes at least one instruction, at least one program, a code set or an instruction set. The at least one instruction, the at least one program, the code set or the instruction set is stored in the memory. The CPU 1201 implements all or some of the steps in the image processing method for a medical image shown in the above embodiments by executing the at least one instruction, the at least one program, the code set or the instruction set.

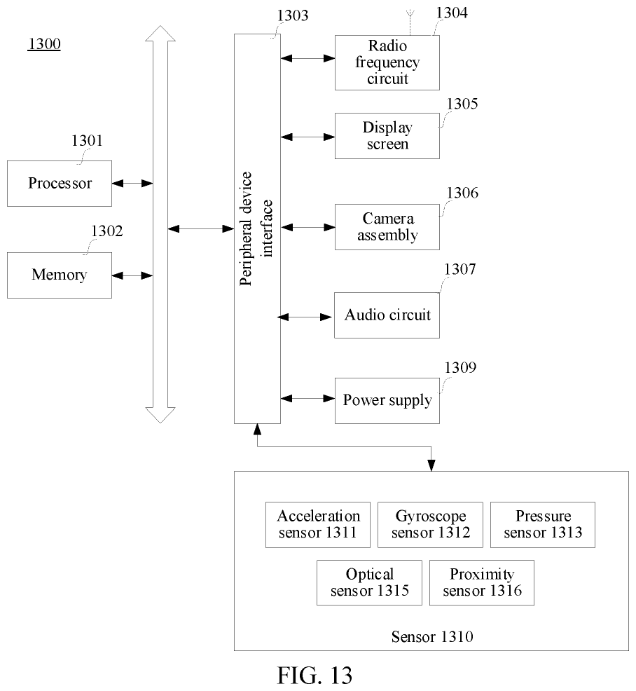

FIG. 13 is a schematic structural diagram of a computer device 1300 according to an exemplary embodiment of this application. The computer device 1300 may be implemented as the terminal, such as a smart phone, a tablet computer, a laptop computer, or a desktop computer. The computer device 1300 may also be called user equipment, a portable terminal, a laptop terminal, a desktop terminal and so on.

Generally, the computer device 1300 includes: a processor 1301 and a memory 1302.

The processor 1301 may include one or more processing cores, for example, a 4-core processor or a 13-core processor. The processor 1301 may be implemented in at least one hardware form of a Digital Signal Processor (DSP), a Field-Programmable Gate Array (FPGA), and a Programmable Logic Array (PLA). The processor 1301 may also include a main processor and a co-processor. The main processor is a processor configured to process data in a wakeup state, also called a Central Processing Unit (CPU). The co-processor is a low-power processor configured to process data in a standby state. In some embodiments, the processor 1301 may be integrated with a Graphics Processing Unit (GPU), which is configured to render and draw the content that needs to be displayed on a display screen. In some embodiments, the processor 1301 may further include an Artificial Intelligence (AI) processor. The AI processor is configured to process computing operations related to machine learning.

The memory 1302 may include one or more non-transitory computer-readable storage media. The computer-readable storage medium may be non-transient. The memory 1302 may further include a high-speed random access memory and a nonvolatile memory, for example, one or more disk storage devices or flash storage devices. In some embodiments, the non-transient computer-readable storage medium in the memory 1302 is configured to store at least one instruction. The at least one instruction, when executed by the processor 1301, implements all or some of the steps of the image processing method for a medical image according to the method embodiments of this application.

In some embodiments, the computer device 1300 may optionally further include: a peripheral device interface 1303 and at least one peripheral device. The processor 1301, the memory 1302, and the peripheral device interface 1303 may be connected to each other through a bus or a signal line. Each peripheral device may be connected to the peripheral device interface 1303 through the bus, the signal line, or a circuit board. Specifically, the peripheral device includes: at least one of a radio frequency circuit 1304, a display screen 1305, a camera assembly 1306, an audio circuit 1307, and a power supply 1309.

The peripheral device interface 1303 may be configured to connect at least one peripheral device related to Input/Output (I/O) to the processor 1301 and the memory 1302. In some embodiments, the processor 1301, the memory 1302 and the peripheral device interface 1303 are integrated on the same chip or circuit board. In some other embodiments, any one or two of the processor 1301, the memory 1302, and the peripheral device interface 1303 may be implemented on a separate chip or circuit board, which is not limited in this embodiment.

In some embodiments, the computer device 1300 also includes one or more sensors 1310. The one or more sensors 1310 include, but are not limited to: an acceleration sensor 1311, a gyroscope sensor 1312, a pressure sensor 1313, an optical sensor 1315, and a proximity sensor 1316.

Those skilled in the art can understand that the structure shown in FIG. 13 does not constitute a limitation on the computer device 1300, and may include more or fewer components than shown in the figure, or combine some components, or adopt different component arrangements.

In an exemplary embodiment, also provided is a non-transitory computer-readable storage medium for storing at least one instruction, at least one program, a code set or an instruction set. The at least one instruction, the at least one program, the code set, or the instruction set is loaded or executed by a processor to implement all or some of the steps of the image processing method for a medical image. For example, the computer-readable storage medium may be a Read-Only Memory (ROM), a Random Access Memory (RAM), a Compact Disc Read-Only Memory (CD-ROM), a magnetic tape, a floppy disk, an optical data storage device, or the like.

In an exemplary embodiment, also provided is a computer program product or a computer program, including computer instructions stored in a non-transitory computer-readable storage medium. A processor of a computer device reads the computer instructions from the computer-readable storage medium. The processor executes the computer instructions so that the computer device executes all or some of the steps of the method as shown in any embodiment of FIG. 2, FIG. 4, or FIG. 5.

In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. A method for processing a medical image performed by a computer device, the method comprising:
calling a first coding network in an image processing model to code a first sample image of a first mode of a target medical object, to obtain a first feature map of the first sample image;
calling a decoding network in the image processing model to perform decoding based on the first feature map, to obtain a predictive segmentation image of the first sample image, the predictive segmentation image being used for indicating at least one predicted specified type region within the first sample image;
calling a generative network in the image processing model to generate a predictive generation image based on the first feature map, the predictive generation image being a prediction image of a second mode of the first sample image; and
training the image processing model based on a difference between the predictive segmentation image and a tag image of the target medical object and a difference between the predictive generation image and a second sample image of a second mode of the target medical object, and the tag image indicating the at least one specified type region of the target medical object.

2. The method according to claim 1, wherein the training the image processing model based on a difference between the predictive segmentation image and a tag image of the target medical object and a difference between the predictive generation image and a second sample image of a second mode of the target medical object comprises:
determining a function value of a first loss function based on the difference between the predictive segmentation image and the tag image;
determining a function value of a second loss function based on the difference between the predictive generation image and the second sample image; and
training the image processing model based on the function value of the first loss function and the function value of the second loss function.

3. The method according to claim 2, wherein the training the image processing model based on the function value of the first loss function and the function value of the second loss function comprises:
updating a parameter of the first coding network and a parameter of the decoding network based on the function value of the first loss function; and
updating the parameter of the first coding network and a parameter of the generative network based on the function value of the second loss function.

4. The method according to claim 2, wherein the determining a function value of a first loss function based on the difference between the predictive segmentation image and the tag image comprises:
determining a function value of a first branch function of the first loss function based on a similarity between the predictive segmentation image and the tag image;
determining a function value of a second branch function of the first loss function based on a position of at least one specified type region predicted in the predictive segmentation image and a position of at least one specified type region in the tag image; and
determining the function value of the first loss function based on the function value of the first branch function and the function value of the second branch function.

5. The method according to claim 2, further comprising:
calling a discriminator to discriminate the predictive generation image, to obtain a discrimination result of the predictive generation image; and
determining a function value of a third loss function based on the discrimination result, the discrimination result being used for indicating whether the predictive generation image is a real image or not; and
the training the image processing model based on the function value of the first loss function and the function value of the second loss function comprises:
training the image processing model based on the function value of the first loss function, the function value of the second loss function, and the function value of the third loss function.

6. The method according to claim 1, wherein the first coding network comprises N coding layers, and the N coding layers are connected in pairs, N≥2 and is a positive integer; and
the calling a first coding network in an image processing model to code a first sample image, to obtain a first feature map of the first sample image comprises:
obtaining a first image pyramid of the first sample image, the first image pyramid being an image set obtained by down-sampling the first sample image according to a specified gradient, and the first image pyramid comprising N first to-be-processed images; and
respectively inputting the N first to-be-processed images to corresponding coding layers, and coding the N first to-be-processed images to obtain N first feature maps of the first sample image;
wherein in response to a target coding layer being not a first coding layer in the N coding layers, an input of the target coding layer further comprises a first feature map outputted by a previous coding layer.

7. The method according to claim 1, further comprising:
obtaining a priori constraint image of the image processing model based on a third sample image, wherein the third sample image is a sample medical image of a third mode of the target medical object, and the priori constraint image is used for indicating a position of the target medical object in the third sample image;
calling a second coding network in the image processing model to perform coding based on the priori constraint image, to obtain a second feature map of the third sample image; and
merging the first feature map and the second feature map to obtain a comprehensive feature map; wherein
the calling a decoding network in the image processing model to decode based on the first feature map, to obtain a predictive segmentation image of the first sample image comprises:
calling the decoding network in the image processing model to perform decoding based on the comprehensive feature map, to obtain the predictive segmentation image of the first sample image; and
the calling a generative network in the image processing model to generate a predictive generation image based on the first feature map comprises:
calling the generative network in the image processing model to generate the predictive generation image based on the comprehensive feature map.

8. The method according to claim 7, wherein a parameter in the second coding network is shared with a parameter weight in the first coding network.

9. A computer device, comprising a processor and a memory, wherein the memory stores at least one instruction, and the at least one instruction is loaded and executed by the processor and cause the computer device to implement a method for processing a medical image including:
calling a first coding network in an image processing model to code a first sample image of a first mode of a target medical object, to obtain a first feature map of the first sample image;
calling a decoding network in the image processing model to perform decoding based on the first feature map, to obtain a predictive segmentation image of the first sample image, the predictive segmentation image being used for indicating at least one predicted specified type region within the first sample image;
calling a generative network in the image processing model to generate a predictive generation image based on the first feature map, the predictive generation image being a prediction image of a second mode of the first sample image; and
training the image processing model based on a difference between the predictive segmentation image and a tag image of the target medical object and a difference between the predictive generation image and a second sample image of a second mode of the target medical object, and the tag image indicating the at least one specified type region of the target medical object.

10. The computer device according to claim 9, wherein the training the image processing model based on a difference between the predictive segmentation image and a tag image of the target medical object and a difference between the predictive generation image and a second sample image of a second mode of the target medical object comprises:
determining a function value of a first loss function based on the difference between the predictive segmentation image and the tag image;
determining a function value of a second loss function based on the difference between the predictive generation image and the second sample image; and
training the image processing model based on the function value of the first loss function and the function value of the second loss function.

11. The computer device according to claim 10, wherein the training the image processing model based on the function value of the first loss function and the function value of the second loss function comprises:
updating a parameter of the first coding network and a parameter of the decoding network based on the function value of the first loss function; and
updating the parameter of the first coding network and a parameter of the generative network based on the function value of the second loss function.

12. The computer device according to claim 10, wherein the determining a function value of a first loss function based on the difference between the predictive segmentation image and the tag image comprises:
determining a function value of a first branch function of the first loss function based on a similarity between the predictive segmentation image and the tag image;
determining a function value of a second branch function of the first loss function based on a position of at least one specified type region predicted in the predictive segmentation image and a position of at least one specified type region in the tag image; and
determining the function value of the first loss function based on the function value of the first branch function and the function value of the second branch function.

13. The computer device according to claim 9, wherein the first coding network comprises N coding layers, and the N coding layers are connected in pairs, N≥2 and is a positive integer; and
the calling a first coding network in an image processing model to code a first sample image, to obtain a first feature map of the first sample image comprises:
obtaining a first image pyramid of the first sample image, the first image pyramid being an image set obtained by down-sampling the first sample image according to a specified gradient, and the first image pyramid comprising N first to-be-processed images; and
respectively inputting the N first to-be-processed images to corresponding coding layers, and coding the N first to-be-processed images to obtain N first feature maps of the first sample image;
wherein in response to a target coding layer being not a first coding layer in the N coding layers, an input of the target coding layer further comprises a first feature map outputted by a previous coding layer.

14. The computer device according to claim 9, wherein the method further comprises:
obtaining a priori constraint image of the image processing model based on a third sample image, wherein the third sample image is a sample medical image of a third mode of the target medical object, and the priori constraint image is used for indicating a position of the target medical object in the third sample image;
calling a second coding network in the image processing model to perform coding based on the priori constraint image, to obtain a second feature map of the third sample image; and
merging the first feature map and the second feature map to obtain a comprehensive feature map; wherein
the calling a decoding network in the image processing model to decode based on the first feature map, to obtain a predictive segmentation image of the first sample image comprises:
calling the decoding network in the image processing model to perform decoding based on the comprehensive feature map, to obtain the predictive segmentation image of the first sample image; and
the calling a generative network in the image processing model to generate a predictive generation image based on the first feature map comprises:
calling the generative network in the image processing model to generate the predictive generation image based on the comprehensive feature map.

15. The computer device according to claim 14, wherein a parameter in the second coding network is shared with a parameter weight in the first coding network.

16. A non-transitory computer-readable storage medium having at least one computer program stored thereon, the computer program being loaded and executed by a processor of a computer device and causing the computer device to implement a method for processing a medical image including:
calling a first coding network in an image processing model to code a first sample image of a first mode of a target medical object, to obtain a first feature map of the first sample image;
calling a decoding network in the image processing model to perform decoding based on the first feature map, to obtain a predictive segmentation image of the first sample image, the predictive segmentation image being used for indicating at least one predicted specified type region within the first sample image;
calling a generative network in the image processing model to generate a predictive generation image based on the first feature map, the predictive generation image being a prediction image of a second mode of the first sample image; and
training the image processing model based on a difference between the predictive segmentation image and a tag image of the target medical object and a difference between the predictive generation image and a second sample image of a second mode of the target medical object, and the tag image indicating the at least one specified type region of the target medical object.

17. The non-transitory computer-readable storage medium according to claim 16, wherein the training the image processing model based on a difference between the predictive segmentation image and a tag image of the target medical object and a difference between the predictive generation image and a second sample image of a second mode of the target medical object comprises:
determining a function value of a first loss function based on the difference between the predictive segmentation image and the tag image;
determining a function value of a second loss function based on the difference between the predictive generation image and the second sample image; and
training the image processing model based on the function value of the first loss function and the function value of the second loss function.

18. The non-transitory computer-readable storage medium according to claim 17, wherein the training the image processing model based on the function value of the first loss function and the function value of the second loss function comprises:
updating a parameter of the first coding network and a parameter of the decoding network based on the function value of the first loss function; and
updating the parameter of the first coding network and a parameter of the generative network based on the function value of the second loss function.

19. The non-transitory computer-readable storage medium according to claim 17, wherein the determining a function value of a first loss function based on the difference between the predictive segmentation image and the tag image comprises:
determining a function value of a first branch function of the first loss function based on a similarity between the predictive segmentation image and the tag image;
determining a function value of a second branch function of the first loss function based on a position of at least one specified type region predicted in the predictive segmentation image and a position of at least one specified type region in the tag image; and
determining the function value of the first loss function based on the function value of the first branch function and the function value of the second branch function.

20. The non-transitory computer-readable storage medium according to claim 16, wherein the first coding network comprises N coding layers, and the N coding layers are connected in pairs, N≥2 and is a positive integer; and
the calling a first coding network in an image processing model to code a first sample image, to obtain a first feature map of the first sample image comprises:
obtaining a first image pyramid of the first sample image, the first image pyramid being an image set obtained by down-sampling the first sample image according to a specified gradient, and the first image pyramid comprising N first to-be-processed images; and
respectively inputting the N first to-be-processed images to corresponding coding layers, and coding the N first to-be-processed images to obtain N first feature maps of the first sample image;
wherein in response to a target coding layer being not a first coding layer in the N coding layers, an input of the target coding layer further comprises a first feature map outputted by a previous coding layer.
